(19) United States
(12) Patent Application Publication
(10) Pub. No.: US 2015/0280493 A1
(43) Pub. Date: Oct. 1, 2015

(54) METHOD FOR CONTROLLING POWER SUPPLY AND ELECTRONIC DEVICE

(71) Applicant: Samsung Electronics Co., Ltd., Suwon-si (KR)

(72) Inventors: Jae Deok CHA, Yongin-si (KR); Sang Ju KIM, Suwon-si (KR); In Sung HWANG, Seoul (KR); Hye Jung CHO, Anyang-si (KR); Dae Hwan KIM, Hwaseong-si (KR); Yong Bum HA, Hwaseong-si (KR)

(21) Appl. No.: 14/672,651

(22) Filed: Mar. 30, 2015

(30) Foreign Application Priority Data
Apr. 1, 2014 (KR) 10-2014-0038451

(51) Int. Cl. H02J 9/06; H02J 7/00

(52) U.S. Cl. CPC H02J 9/061; H02J 7/007

(57) ABSTRACT

An electronic device is provided. The electronic device includes a switch configured to selectively connect power supplied from a power adaptor connected to the electronic device, a system load configured to be included in the electronic device and to receive power from the power adaptor or a battery connected to the electronic device according to on/off of the switch, and a controller configured to turn off the switch when entering an emergency power mode in a state where the power adaptor is connected to the electronic device.

### CROSS-REFERENCE TO RELATED APPLICATION(S)

This application claims the benefit under 35 U.S.C. §119(a) of a Korean patent application filed on Apr. 1, 2014 in the Korean Intellectual Property Office and assigned Serial No. 10-2014-0038451, the entire disclosure of which is hereby incorporated by reference.

### TECHNICAL FIELD

The present disclosure relates to a method for controlling a power supply and an electronic device.

### BACKGROUND

Recently, there has been an increase in power consumption due to the wide use of mobile electronic devices, global warming, and abnormal climate occurrence. These and other events have caused a shortage of power supply, especially at peak times of power consumption in summer and winter seasons. To address these issues, various measures for emergency power supply are being proposed. However, they are not significantly effective because they cause an inconvenience or burdensome costs to users.

The above information is presented as background information only to assist with an understanding of the present disclosure. No determination has been made, and no assertion is made, as to whether any of the above might be applicable as prior art with regard to the present disclosure.

### SUMMARY

Various embodiments of the present disclosure are to address at least the above-mentioned problems and/or disadvantages and to provide at least the advantages described below. Accordingly, an embodiment of the present disclosure is to provide a method for controlling power supply and an electronic device employing the method.

Another embodiment of the present disclosure is to provide a computer readable recording medium having thereon a program for executing the method on the computer.

In accordance with an embodiment of the present disclosure, an electronic device is provided. The electronic device includes a switch configured to selectively adjust power supply from a power adaptor connected to the electronic device, a system load configured to receive power from the power adaptor or a battery connected to the electronic device, and a controller configured to turn off the switch when entering an emergency power mode in a state where the power adaptor is connected to the electronic device.

In accordance with another embodiment of the present disclosure, an electronic device is provided. The electronic device includes a system load configured to receive power from a power adaptor or a battery connected to the electronic device, and a controller configured to perform a control to transmit, to the power adaptor, a signal for turning off a switch included in the power adaptor when entering the emergency power mode in a state where the power adaptor is connected to the electronic device.

In accordance with another embodiment of the present disclosure, a method for controlling power supply is provided. The method includes determining whether a power adaptor is connected to an electronic device, turning off a switch for supplying power from the power adaptor, when the electronic device is connected to the power adaptor to enter an emergency power mode, cutting off power supplied from the power adaptor in response to the turning off of the switch, and supplying power from a battery attached to the electronic device to a system load of the electronic device.

Other embodiments, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other embodiments, features, and advantages of certain embodiments of the present disclosure will be more apparent from the following description taken in conjunction with the accompanying drawings, in which:

FIG. 1 is a block diagram of an electronic device according to various embodiments of the present disclosure;

FIG. 2 is a block diagram of an electronic device according to various embodiments of the present disclosure;

FIG. 3 is a block diagram of an electronic device according to various embodiments of the present disclosure;

FIG. 4 is a block diagram of an electronic device according to various embodiments of the present disclosure;

FIG. 5 is a block diagram of an electronic device according to various embodiments of the present disclosure;

FIG. 6 is a user interface screen on which an emergency power mode is set according to various embodiments of the present disclosure;

FIG. 7 is a user interface screen on which an emergency power mode is set according to various embodiments of the present disclosure;

FIG. 8A is an emergency power mode screen for power consumption consumed by the electronic device of the present disclosure;

FIG. 8B is a normal mode screen for power consumption consumed by the electronic device of the present disclosure; and

FIG. 9 is a flowchart of a method for controlling power supply in an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions “include,” “comprise,” “including,” or “comprising,” used in various embodiments of the present disclosure specify a corresponding function, operation or element but do not limit at least one additional function, operation, or element. It will be further understood that the terms “comprises”, “comprising,”, “includes” and/or “including”, when used herein, specify the presence of stated features, numbers, steps, operations, elements, components or combinations thereof, but do not preclude the presence or addition of one or more other features, numbers, steps, operations, elements, components, or combinations thereof.

In various embodiments of the present disclosure, the expression “or” may include any or all possible combinations of items listed together. For instance, the expression “A or B” may include A, B, or both A and B.

The expressions such as “1st”, “2nd”, “first”, “second”, and the like used herein may modify various different elements of various embodiments, but do not limit the elements. For instance, such expressions do not limit the order and/or importance of corresponding components. The expressions may be used to distinguish one element from another element. For instance, both a first user device and a second user device indicate a user device but indicate different user devices from each other. For example, a first element could be termed a second element, and similarly, a second element could be termed a first element, without departing from the scope of right of various embodiments of the present disclosure.

It will be understood that when an element is referred to as being “connected” or “coupled” to another element, it may be directly connected or coupled to the other element or another new/different element may be intervened between the element and the other element. In contrast, it will be understood that when an element is referred to as being “directly connected” or “directly coupled” to another element, another new/different element is not intervened between the element and the other element.

Terms used in this specification are used to describe various embodiments, and are not intended to limit application of the present disclosure. The terms of a singular form may include plural forms, unless the context clearly indicates otherwise.

Unless otherwise indicated, all the terms used herein, which include technical or scientific terms, may have the same meaning as that generally understood by a person skilled in the art. The terms defined in a generally used dictionary should be considered to have the same meaning as the contextual meaning of the related art, and unless clearly defined herein, the terms should not be understood abnormally or to have an excessively formal meaning.

An electronic device according to various embodiments of the present disclosure may be a device having a communication function. For instance, electronic devices may include at least one of smart phones, tablet personal computers (PCs), mobile phones, video phones, electronic book (e-book) readers, desktop PCs, laptop PCs, netbook computers, personal digital assistants (PDAs), portable multimedia player (PMPs), MP3 players, mobile medical devices, cameras, and wearable devices (e.g., head-mounted-devices (HMDs) such as electronic glasses, electronic apparel, electronic bracelets, electronic necklaces, electronic appcessories, electronic tattoos, and smart watches).

According to various embodiments of the present disclosure, an electronic device may be smart home appliances having a communication function. The smart home appliances may include at least one of, for example, televisions, digital versatile disc (DVD) players, audio systems, refrigerators, air conditioners, cleaners, ovens, microwave ovens, washing machines, air cleaners, set-top boxes, television (TV) boxes (e.g., Samsung HomeSync™, Apple TV™ or Google TV™), game consoles, electronic dictionaries, electronic keys, camcorders, and electronic picture frames.

According to various embodiments of the present disclosure, an electronic device may include at least one of various medical devices (for example, magnetic resonance angiography (MRA) devices, magnetic resonance imaging (MRI) devices, computed tomography (CT) devices, medical imaging devices, ultrasonic devices, etc.), navigation devices, global positioning system (GPS) receivers, event data recorders (EDRs), flight data recorders (FDRs), vehicle infotainment devices, marine electronic equipment (for example, marine navigation systems, gyro compasses, etc.), avionics, security equipment, vehicle head units, industrial or household robots, financial institutions' automatic teller machines (ATMs), and stores' points of sale (POS).

According to various embodiments of the present disclosure, an electronic device may include a portion of furniture or buildings/structures having a communication function, electronic boards, electronic signature receiving devices, projectors, and various measuring instruments (for example, water, electricity, gas, or radio wave measuring instruments). In various embodiments of the present disclosure, an electronic device may be one of the above-mentioned various devices or a combination thereof. Additionally, an electronic device according to various embodiments of the present disclosure may be a flexible device. Furthermore, it should be apparent to a person skilled in the art that an electronic device according to various embodiments of the present disclosure is not limited to the above-mentioned devices.

Hereinafter, an electronic device according to various embodiments of the present disclosure will be described in more detail with reference to the accompanying drawings. The term “user” in various embodiments may refer to a person using an electronic device or a device using an electronic device (for example, an artificial intelligent electronic device).

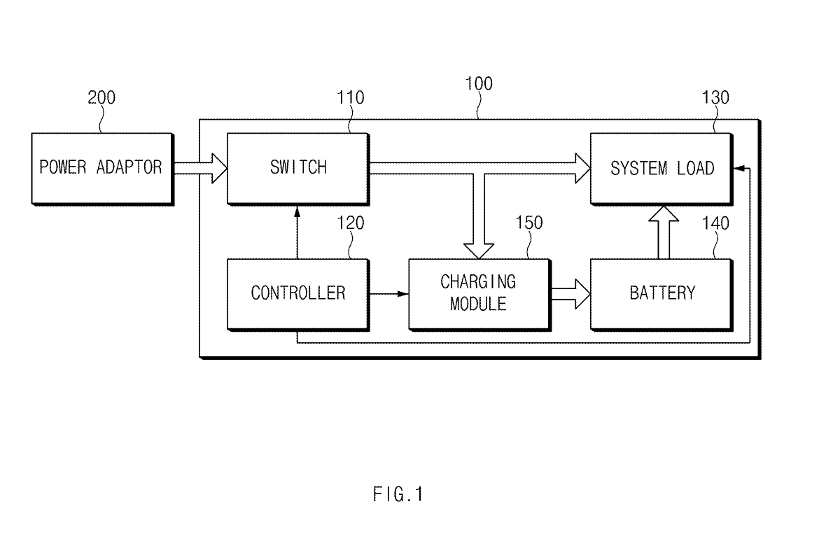

FIG. 1 is a block diagram of an electronic device according to various embodiments of the present disclosure.

Referring to FIG. 1, an electronic device 100 may be configured with a switch 110, a controller 120, a system load 130, a battery 140, and a charging module 150.

Descriptions will be provided only about elements related to the present embodiment so as not to obscure the various features of the present embodiment. Accordingly, a person skilled in the art will understand that other general elements may be further included besides the elements illustrated in FIG. 1.

The switch 110 may adjust (e.g., open or close) power supplied from a power adaptor 200 connected to the electronic device 100. According to an embodiment of the present disclosure, when the electronic device 100 is in a normal mode and the power adaptor 200 is connected to the electronic device 100, the switch is turned on to supply power to the system load 130. The normal mode represents a state of not being in an emergency power mode. The emergency power mode represents a mode in which power supplied from the power adaptor 200 connected to the electronic device 100 is cut off or otherwise unavailable. According to an embodiment of the present disclosure, the electronic device 100 may enter the emergency power mode according to a user setting or a signal from a server.

When the electronic device 100 activates (or enters) the emergency power mode in a state where the power adaptor 200 is connected to the electronic device 100, the switch 110 is turned off to cut off power supplied from the power adaptor 200. Power supplied from the power adaptor 200 to the system load 130 or the charging module 150 may be cut off.

According to an embodiment of the present disclosure, the switch 110 may be implemented with a transistor (e.g., field effect transistor (FET)). However, the switch 110 is not limited hereto and may be implemented with various types of switches capable of cutting off power supplied from the power adaptor 200.

The controller 120 controls switching (i.e., on/off) of the switch 110 according to whether the electronic device 100 is in an emergency power mode. In a state where the power adaptor 200 is connected to the electronic device 100, when the electronic device 100 activates (or enters) the emergency power mode, the controller 120 may turn off the switch 110. In a state where the power adaptor 200 is connected to the electronic device 100, when the electronic device 100 is in a normal mode, the controller 120 may turn on the switch 110. That is, when the electronic device 100 is in a normal mode, the controller 120 may control the switch 110 to a closed position in order to make an electrical contact (or physical contact) between the power adaptor 200 and the electronic device 100.

The controller 120 may perform a control so that the electronic device 100 enters an emergency power mode by a user setting or a signal received from a server (not illustrated).

According to an embodiment of the present disclosure, the controller 120 may allow the electronic device 100 to enter the emergency power mode according to a user setting. The controller 120 may receive a user input for setting, through a user interface unit (not illustrated), a condition in which the electronic device 100 is to enter the emergency power mode. For example, a user may set a time to enter the emergency power mode, remaining capacity of the battery 140 for entering the emergency power mode, a ratio of the remaining capacity to the entire available capacity, etc., through the user interface unit (not illustrated).

According to an embodiment of the present disclosure, the controller 120 may allow the electronic device 100 to enter the emergency power mode according to the signal from the server (not illustrated). For example, the controller 120 may receive, from the server (not illustrated), a command for allowing the electronic device 100 to enter the emergency power mode. Alternatively, the controller 120 may receive from the server (not illustrated) a setting condition for allowing the electronic device 100 to enter the emergency power mode.

According to an embodiment of the present disclosure, the condition for entering the emergency power mode may be preset. For example, the condition for entering the emergency power mode may be that a current time corresponds to a first time and a capacity of the battery 140 is a first setting value or greater. When the capacity of the battery 140 is the first setting value or greater, the controller 120 may allow the electronic device 100 to enter the emergency power mode. The first setting value may represent a ratio of remaining capacity to the entire available capacity of the battery 140.

The controller 120 may perform a control so that the electronic device 100 deactivates (or exits) the emergency power mode by a user setting or a signal received from a server (not illustrated).

The controller 120 may release the emergency power mode of the electronic device 100 according to the user setting. The controller 120 may receive a user input for setting a condition in which the electronic device 100 exits the emergency power mode through the user interface unit (not illustrated). For example, the user may set a time to exit the emergency power mode, remaining capacity of the battery 140 for getting out of the emergency power mode, a ratio of the remaining capacity to the entire available capacity of the battery 140, etc., through the user interface unit (not illustrated).

According to an embodiment of the present disclosure, the controller 120 may release the emergency power mode of the electronic device 100 according to the signal from the server (not illustrated). For example, the controller 120 may receive a command for releasing the emergency power mode of the electronic device 100 from the server (not illustrated). Alternatively, the controller 120 may receive a setting condition for releasing the emergency power mode of the electronic device 100 from the server (not illustrated).

According to an embodiment of the present disclosure, the condition for releasing the emergency power mode may be preset. For example, the condition for getting out of the emergency power mode may be that a current time becomes a second time and a capacity of the battery 140 is smaller than a second setting value. When the second time arrives or the capacity of the battery 140 is smaller than the second setting value, the controller 120 may release the emergency power mode of the electronic device 100. The first setting value may represent a ratio of remaining capacity to the entire available capacity of the battery 140. Hereinafter, for convenience of explanation, the ratio of remaining capacity to the entire available capacity of the battery 140 is called a battery capacity ratio.

According to reduction of the entire available capacity by battery charging and discharging, the controller 120 may adjust the setting condition for entering and releasing the emergency power mode, which is set in the controller 120. The setting condition may be at least one of a setting condition set by the user, a setting condition set by the signal received from the server (not illustrated), and a setting condition preset in the electronic device 100.

For example, when the entire capacity initially available in the battery 140 is 1000 mAh, the entire available capacity may be reduced to 500 mAh by the repetitive charging and discharging of the battery. The battery capacity ratio may be set to 20% as one of the setting conditions for allowing the electronic device 100 to enter the emergency power mode. Since the entire available capacity of the battery 140 is initially 1000 mAh, the electronic device 100 enters the emergency power mode when remaining capacity of the battery 140 is 200 mAh. When the entire available capacity is reduced to 500 mAh, the electronic device 100 enters the emergency power mode when the remaining capacity of the battery 140 is 100 mAh. Even in a place where the power adaptor 200 is not available, the user may desire to use the electronic device 100 for some time after the power adaptor 200 is removed from the electronic device 100. Under an assumption that the user uses the battery 140 at a rate of 200 mA/hour, in a case where the electronic device 100 enters the emergency power mode when the remaining capacity of the battery 140 is 200 mAh, the user may use the electronic device 100 for one hour. On the contrary, in a case where the electronic device 100 enters the emergency power mode when the remaining capacity of the battery 140 is 100 mAh, the user may use the electronic device 100 only for 30 minutes. Since a time for using the electronic device 100 after removal of the power adaptor 200 is reduced by the entry into the emergency power mode, the user may feel an inconvenience due to entry into the emergency power mode.

According to a reduction of the entire available capacity by battery charging and discharging, the controller 120 may automatically adjust the setting condition for entering or releasing the emergency power mode, which is set in the controller 120. The electronic device 100 may not enter the emergency power mode according to a state of the battery 140.

According to an embodiment of the present disclosure, the controller 120 may adjust the time or the battery capacity ratio to enter the emergency power mode on the basis of a lookup table storing a setting condition corresponding to the entire available capacity.

For example, a first time and first setting value may be set as the setting condition for entering the emergency power mode, and a second time and second setting value may be set as the setting condition for releasing the emergency power mode. The lookup table may store at least one of the first time, first setting value, second time, and second setting value that correspond to the entire available capacity. The controller 120 may obtain the first time, the first setting value, the second time, or the second setting value that corresponds to current entire available capacity of the battery 140 and adjust the setting condition for entering or releasing the emergency power mode.

According to an embodiment of the present disclosure, the controller 120 may adjust a time or a battery capacity ratio to enter the emergency power mode according to reduced entire available capacity by using a specific algorithm.

For example, a first time and first setting value may be set as the setting condition for entering the emergency power mode, and the second time and second setting value may be set as a setting condition for releasing the emergency power mode. The controller 120 may obtain the first time, the first setting value, the second time, or the second setting value that corresponds to current entire available capacity of the battery 140 by using a specific algorithm. The controller 120 may adjust the setting condition for entering or releasing the emergency power mode according to the obtained first time, first setting value, second time, or second setting value.

The controller 120 may check whether the battery 140 is abnormal and keep the switch 110 turned on when the battery 140 is abnormal as a result of the check. When the battery 140 is abnormal and cannot supply power necessary for the system load 130, the electronic device 100 may not be allowed to enter the emergency power mode in order to prevent the electronic device 100 from operating.

The controller 120 may reduce power consumption of the electronic device 100 when entering the emergency power mode.

According to an embodiment of the present disclosure, the controller 120 may allow the electronic device 100 to enter a low power mode at the time of entering the emergency power mode. In the low power mode, the electronic device 100 may reduce power consumption thereof by adjusting brightness of a display device or adjusting a status of a central processing unit (CPU).

According to an embodiment of the present disclosure, the controller 120 may temporally hold an update or downloading in order not to perform a system update or downloading involving large power consumption in the emergency power mode. For example, the controller 120 may temporally hold security policy downloading or a window update in the emergency power mode. After the emergency power mode is released, the controller 120 may perform jobs held during the emergency power mode.

The system load 130 receives power from the power adaptor 200 or the battery 140 according to a position (e.g., on/off) of the switch 110. When the electronic device 100 is in the emergency power mode, the system load 130 receives power from the battery 140, not from the power adaptor 200. When the electronic device 100 is in the normal mode, the system load 130 receives power from the power adaptor 200.

For example, the system load 130 may include a power management module (not illustrated) for performing conversion of power supplied from the power adaptor 200 or the battery 140 to be proper for an operation voltage of each unit, a direct current (DC)-DC regulator, a buck converter, a low dropout regulator, a boost converter, a switching regulator, or each unit of the electronic device 100. However, the system load 130 is not limited hereto and may include all elements, modules or devices performing conversion on or consuming power supplied from the power adaptor 200 or the battery 140.

When the electronic device 100 enters the emergency power mode in a state of being connected to the power adaptor 200, the battery 140 may supply power to the system load 130. Alternatively, when the power adaptor 200 is disconnected from the electronic device 100, the battery 140 may supply power to the system load 130. According to an embodiment, the battery 140 may be a multi-cell in which one or more battery cells are coupled in serial or parallel.

The charging module 150 may receive power from the power adaptor 200 when the switch 110 is on. The charging module 150 may perform conversion of power supplied from the power adaptor 200 to charge the battery 140. When the switch 110 is off, the power is not supplied to the charging module 150.

The power adaptor 200 performs conversion on a voltage supplied from an external power source to supply the converted result to the electronic device 100. For example, the power adaptor 200 may convert commercial AC power into a DC voltage used in the electronic device 100 and supply the DC voltage to the electronic device 100. When the power adaptor 200 is connected to the electronic device 100, the controller 120 may determine whether the power adaptor 200 is connected, or whether the power adaptor 200 available to the electronic device 100 is connected.

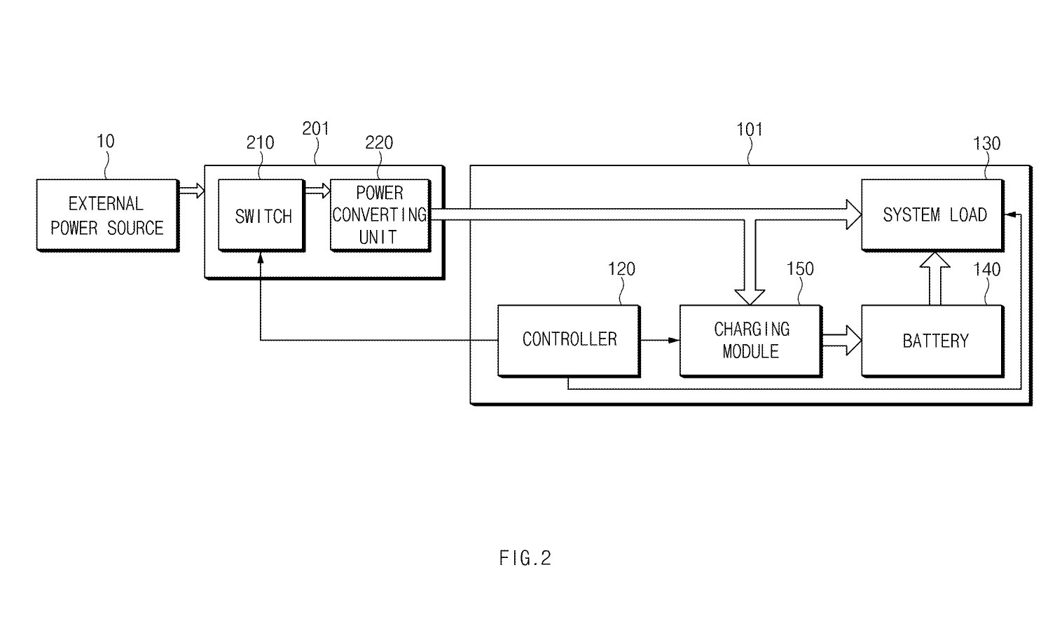

FIG. 2 is a block diagram of an electronic device according to various embodiments of the present disclosure.

Referring to FIG. 2, an electronic device 101 may control a switch 210 of a power adaptor 201 to open or close power supply of the power adaptor 201. The power adaptor 201 includes the switch 210 and a power converting unit 220, and the electronic device 101 includes a controller 120, a system load 130, a battery 140 and a charging module 150.

The system load 130, battery 140, and charging module 150 illustrated in FIG. 1 respectively correspond to the system load 130, battery 140, and charging module 150 illustrated in FIG. 2. Accordingly, even though omitted in the present embodiment, it may be seen that the content described in relation to the system load 130, battery 140, and charging module 150 illustrated in FIG. 1 may also be applied to descriptions about the system load 130, battery 140, and charging module 150 illustrated in FIG. 2.

The power adaptor 201 according to the present embodiment may be a power adaptor having an adaptor Identification (ID). The power adaptor 201 may control power supplied to the electronic device 101 on the basis of a signal received from the controller 120 of the electronic device 101.

The switch 210 switches (i.e., opens or closes) to selectively supply power from the power adaptor 201 according to a signal received from the controller 120 of the electronic device 101. In a state where the power adaptor 201 is connected to the electronic device 101, when the electronic device 101 enters an emergency power mode, the controller 120 transmits the signal to the switch 210. The switch 210 may be turned off according to the signal received from the controller 120. Accordingly, power supply of the power adaptor 201 may be cut off. The emergency power mode may represent a mode in which power supplied from the power adaptor 201 is cut off. According to an embodiment, the switch 210 may be implemented with various types of switches that may cut off the power supply of the power adaptor 201.

The power converting unit 220 converts a voltage supplied from an external power source 10 to supply the converted result to the electronic device 101. According to an embodiment, the power converting unit 220 may convert an AC voltage supplied from the external power source 10 into a DC voltage to supply the DC voltage to the electronic device 101. The power converting unit 220 according to the present embodiment may include an analog-to-digital converter or a DC-DC converter.

The electronic device 101 receives power from the power adaptor 201 connected thereto in the normal mode to supply the power to the system load 130. In an emergency power mode, since the power supplied from the power adaptor 201 is cut off, the system load 130 may use power of the battery 140.

The controller 120 controls switching (i.e., on/off) of the switch 201 by transmitting a signal to the power adaptor 201 according to whether the electronic device 101 is in an emergency power mode. In a state where the power adaptor 201 is connected to the electronic device 101, when the electronic device 101 enters the emergency power mode, the controller 120 may turn off the switch 210. The controller 120 may perform a control so that the electronic device 101 enters the emergency power mode on the basis of a user setting or a signal received from a server (not illustrated). In addition, the controller 120 may perform a control so that the electronic device 101 deactivates (or exits) the emergency power mode on the basis of a user setting or a signal received from the server (not shown).

According to reduction of the entire available capacity by battery charging and discharging, the controller 120 may automatically adjust the setting condition for entering or releasing the emergency power mode, which is set in the controller 120. For example, the controller 120 may adjust a time or a battery capacity ratio to enter the emergency power mode according to reduced entire available capacity by using a lookup table storing a setting condition corresponding to the entire available capacity or a specific algorithm in which a setting condition corresponding to the entire available capacity is obtained.

The controller 120 may check whether the battery 140 is abnormal and when the battery 140 is abnormal according to the checked result, maintain the switch 210 on. When the battery 140 is abnormal and cannot supply power necessary for the system load 130, the electronic device 101 may not be allowed to enter the emergency power mode in order to prevent the electronic device 101 from operating.

The system load 130 may receive power from the power adaptor 201 or the battery 140 according to a position (e.g., on/off) of the switch 210. When the electronic device 101 is in the emergency power mode, the system load 130 receives power from the battery 140.

When the electronic device 101 enters the emergency power mode in a state of being connected to the power adaptor 201, the battery 140 may supply power to the system load 130. According to an embodiment of the present disclosure, the battery 140 may be a multi-cell in which one or more battery cells are combined in serial or parallel.

When the switch 210 is on, the charging module 150 may perform conversion on power supplied from the power adaptor 201 to charge the battery 140.

According to various embodiments of the present disclosure, an electronic device may include a system load of the electronic device, which receives power from a power adaptor or a battery connected to the electronic device, and a controller for performing a control to transmit a signal for turning off a switch included in the power adaptor to the power adaptor, when the electronic device enters an emergency power mode in a state where the power adaptor is connected to the electronic device.

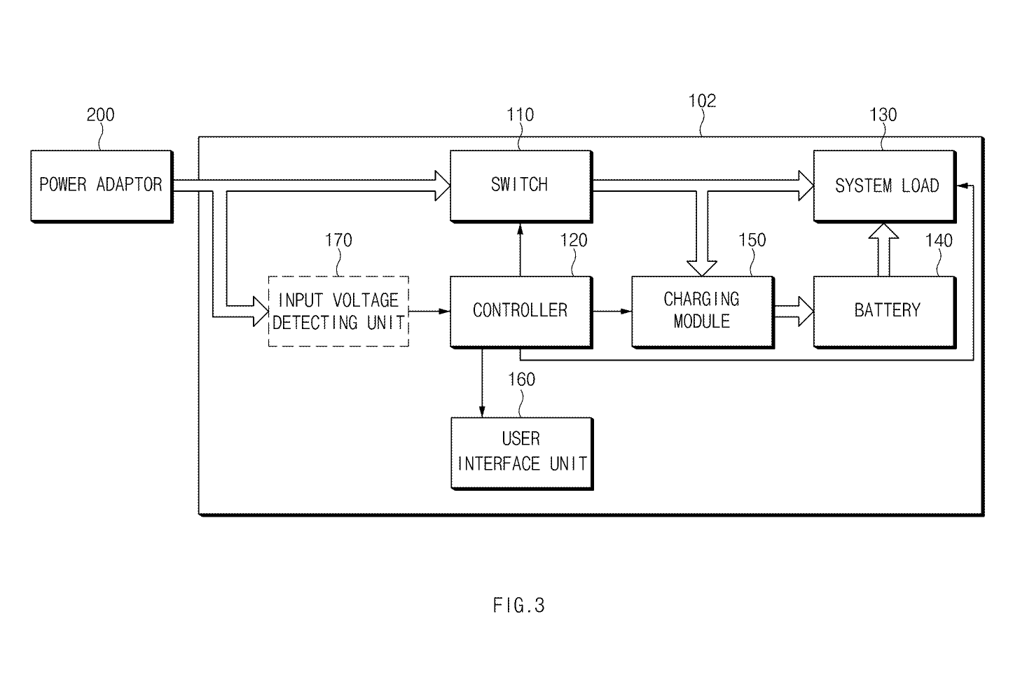

FIG. 3 is a block diagram of an electronic device according to various embodiments of the present disclosure.

Referring to FIG. 3, an electronic device 102 according to an embodiment of the present disclosure may enter an emergency power mode by a user setting. The electronic device 102 may be configured with a switch 110, a controller 120, a system load 130, a battery 140, a charging module 150, and a user interface unit 160.

The system load 130, battery 140, charging module 150, and power adaptor 200 illustrated in FIG. 3 respectively correspond to the system load 130, battery 140, charging module 150, and power adaptor 200 illustrated in FIG. 1.

The switch 110 switches (i.e., opens or closes) to selectively supply power from the power adaptor 200 connected to the electronic device 102. When the power adaptor 200 is connected to the electronic device 102, the switch 110 may be turned on. In a state where the power adaptor 200 is connected to the electronic device 102, when the electronic device 102 enters the emergency power mode, the switch 110 is turned off to cut off power supplied from the power adaptor 200. Power supplied from the power adaptor 200 to the system load 130 or the charging module 150 may be cut off. The emergency power mode represents a mode in which power supplied from the power adaptor 200 connected to the electronic device 102 is cut off.

According to an embodiment of the present disclosure, the switch 110 may be implemented with a transistor (e.g., FET, bipolar-junction transistor (BJT), a metal oxide silicon FET (MOSFET), etc.). However, the switch 110 is not limited hereto and may be implemented with various types of switches capable of cutting off power from the power adaptor 200.

The controller 120 controls switching (i.e., on/off) of the switch 110 according to whether the electronic device 102 is in an emergency power mode. In a state where the power adaptor 200 is connected to the electronic device 102, when the electronic device 102 enters the emergency power mode, the controller 120 may turn off the switch 110.

According to an embodiment of the present disclosure, the controller 120 may allow the electronic device 102 to enter the emergency power mode according to the user setting. The controller 120 may set a condition in which the electronic device 102 enters the emergency power mode according to a user input that is input through the user interface unit 160. Alternatively, the controller 120 may release the emergency power mode of the electronic device 102 according to the user setting. The controller 120 may set a condition for releasing the emergency power mode of the electronic device 102 according to a user input that is input through the user interface unit 160.

The controller 120 may control switching (i.e., on/off) of the switch 110 according to a signal received from an input voltage detecting unit 170. The controller 120 may perform a control to turn off the switch 110 according to a signal received by the input voltage detecting unit 170, when power supplied from the power adaptor 200 is not available.

According to a reduction of the entire available capacity by battery charging and discharging, the controller 120 may adjust the setting condition for entering and releasing the emergency power mode, which is set in the controller 120. The controller 120 may receive, through the user interface unit 160, a user input representing whether auto tuning is set according to the reduction of the entire available capacity.

For example, the controller 120 may adjust a time or a battery capacity ratio to enter the emergency power mode according to the reduced entire available capacity by using a lookup table storing a setting condition corresponding to the entire available capacity or a specific algorithm in which a setting condition corresponding to the entire available capacity is obtained.

The controller 120 may check whether the battery 140 is abnormal and when the battery 140 is abnormal according to the checked result, maintain the switch 110 on. When the battery 140 is abnormal and cannot supply power necessary for the system load 130, the electronic device 102 may not be allowed to enter the emergency power mode in order to prevent the electronic device 102 from operating.

The system load 130 receives power from the power adaptor 200 or the battery 140 according to a position (i.e., on/off) of the switch 110.

When the electronic device 102 enters the emergency power mode in a state of being connected to the power adaptor 200, the battery 140 may supply power to the system load 130.

The charging module 150 may receive power from the power adaptor 200 when the switch 110 is on. When the switch 110 is off, the power is not supplied to the charging module 150.

The user interface unit 160 may receive a user input for setting a condition in which the electronic device 102 enters the emergency power mode. The condition for entering the emergency power mode may be a time to enter the emergency power mode, a remaining capacity of the battery 140 for entering the emergency power mode, or a ratio of remaining capacity to the entire available capacity of the battery 140.

For example, the user may set the electronic device 102 to enter the emergency power mode through the user interface 160 when a time corresponds to a first time and a battery capacity ratio is a first setting value or greater.

The user interface unit 160 may receive a user input for setting a condition in which the electronic device 102 deactivates (or exits) the emergency power mode. The condition for releasing the emergency power mode may be a time to exit the emergency power mode, a remaining capacity of the battery 140 for getting out of the emergency power mode, or a ratio of remaining capacity to the entire available capacity of the battery 140.

For example, when a time becomes a second time and a battery capacity ratio is smaller than the second setting value, the user may set the electronic device 102 to exit the emergency power mode through the user interface 160.

According to various embodiments of the present disclosure, the electronic device 102 may further include the input voltage detecting unit 170. When the power adaptor 200 is connected to the electronic device 102, the input voltage detecting unit 170 may determine whether the power adaptor 200 is connected. In addition, the input voltage detecting unit 170 may determine whether power supplied from the power adaptor 200 connected to the electronic device 102 is available in the electronic device 102. The controller 120 may receive a determination result of the input voltage detecting unit 170 and control a position (i.e., on/off) of the switch 110 according to the determination result. For example, when the input voltage detecting unit 170 determines that the power supplied from the power adaptor 200 is not available in the electronic device 102, the controller 120 may turn off the switch 110. According to an embodiment of the present disclosure, the input voltage detecting unit 170 may be included in the controller 120.

The power adaptor 200 may convert commercial AC power into a DC voltage used in the electronic device 102 and supply the DC voltage to the electronic device 102.

When entering the emergency power mode in a state where the power adaptor 200 is connected to the electronic device 102, the electronic device 102 according to various embodiments of the present disclosure may reduce an amount of the AC power used in the emergency power mode by cutting off the commercial AC power.

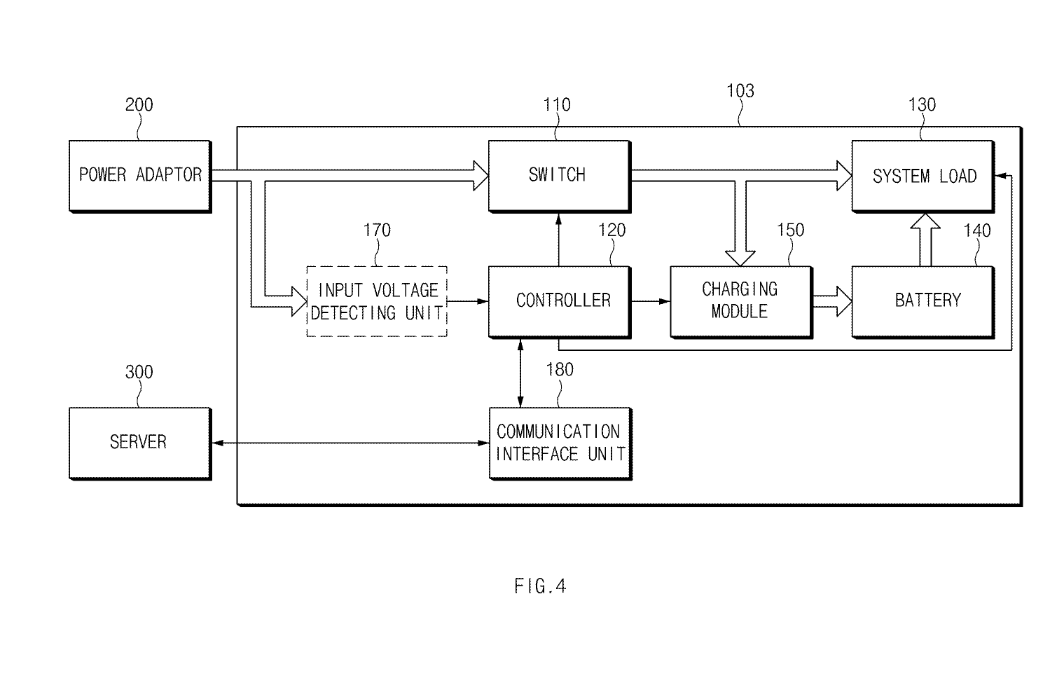

FIG. 4 is a block diagram of an electronic device according to various embodiments of the present disclosure.

Referring to FIG. 4, an electronic device 103 may enter an emergency power mode according to a signal received from a server 300. The electronic device 103 may be configured with a switch 110, a controller 120, a system load 130, a battery 140, a charging module 150, and a communication interface unit 180.

The switch 110, controller 120, system load 130, battery 140, and charging module 150 illustrated in FIG. 4 respectively correspond to the switch 110, controller 120, system load 130, battery 140, and charging module 150 illustrated in FIG. 1. Accordingly, even though omitted in the present embodiment, it may be seen that the content described in relation to the switch 110, controller 120, system load 130, battery 140, and charging module 150 illustrated in FIG. 1 may also be applied to descriptions about the switch 110, controller 120, system load 130, battery 140, and charging module 150 illustrated in FIG. 4.

The switch 110 may adjust (e.g., open or close) power supplied from a power adaptor 200 connected to the electronic device 103. When the power adaptor 200 is connected to the electronic device 103, the switch 110 may be turned on. In a state where the power adaptor 200 is connected to the electronic device 103, when the electronic device 103 enters the emergency power mode, the switch 110 is turned off to cut off power supplied from the power adaptor 200. Power supplied from the power adaptor 200 to the system load 130 or the charging module 150 may be cut off.

The controller 120 controls switching (i.e., on/off) of the switch 110 according to whether the electronic device 103 is in an emergency power mode. In a state where the power adaptor 200 is connected to the electronic device 103, when the electronic device 103 enters the emergency power mode, the controller 120 may turn off the switch 110.

The controller 120 may allow the electronic device 103 to enter the emergency power mode according to the signal received from the server 300.

According to an embodiment of the present disclosure, the controller 120 may receive a command for allowing the electronic device 103 to enter the emergency power mode from the server 300 through the communication interface unit 180. The controller 120 may allow the electronic device 103 to enter the emergency power mode according to the command. According to an entry command from the server 300, the controller 120 may allow the electronic device 103 to enter the emergency power mode and cut off power supplied from the power adaptor 200 by turning off the switch 110 in a state where the power adaptor 200 is connected to the electronic device 103.

When entering the emergency power mode according to the command from the server 300, the electronic device 103 may exit the emergency power mode according to an individual condition of the electronic device 103.

For example, when the power adaptor 200 is disconnected from the electronic device 102 in the emergency power mode, the controller 120 may perform a control so that the electronic device 103 exits the emergency power mode.

As another example, when the server 300 is disconnected from a network in the emergency power mode, the controller 120 may perform a control so that the electronic device 103 exits the emergency power mode.

As another example, when a battery capacity ratio of the electronic device 103 falls to a value smaller than a setting value in the emergency power mode, the controller 120 may perform a control so that the electronic device 103 exits the emergency power mode.

Alternatively, after entering the emergency power mode according to the command from the server 300, the electronic device 103 may exit the emergency power mode according to a release command from the server 300.

According to an embodiment of the present disclosure, the controller 120 may receive a condition for allowing the electronic device 103 to enter the emergency power mode from the server 300 through the communication interface unit 180. After receiving the condition for allowing the electronic device 103 to enter the emergency power mode, the controller 120 may set the condition in the electronic device 103 on the basis of the received condition. The controller 120 may allow the electronic device 103 to enter the emergency power mode according to the set condition and cut off power supplied from the power adaptor 200 by turning off the switch 110 in a state where the power adaptor 200 is connected to the electronic device 103.

In addition, the controller 120 may receive a condition for releasing the emergency power mode of the electronic device 103 from the server 300 through the communication interface unit 180. After receiving the condition for releasing the emergency power mode of the electronic device 103, the controller 120 may set the condition in the electronic device 103 on the basis of the received condition. According to the set condition, the controller 120 may release the emergency power mode of the electronic device 103 and turn on the switch 110 to receive power from the power adaptor 200 in a state where the power adaptor 200 is connected to the electronic device 103.

When a condition for entering or releasing the emergency power mode according to a condition received from the server 300, the electronic device 103 may exit the emergency power mode according to an individual condition of the electronic device 103 or a release command from the server 300.

For example, when the power adaptor 200 is disconnected from the electronic device 103 in the emergency power mode, the controller 120 may perform a control so that the electronic device 103 exits the emergency power mode.

As another example, when a battery capacity ratio of the electronic device 103 falls to a value smaller than a setting value in the emergency power mode, the controller 120 may perform a control so that the electronic device 103 exits the emergency power mode.

According to reduction of the entire available capacity by battery charging and discharging, the controller 120 may adjust a condition for entering and releasing the emergency power mode, which is set in the controller 120. The controller 120 may automatically adjust a setting condition according to reduction of the entire available capacity. Alternatively, the controller 120 may receive a user input representing whether auto tuning is set according to the reduction of the entire available capacity to perform a control to automatically adjust a setting condition according to a user setting. Even though an entry or release condition is set by the server 300, the set condition may be adjusted to be proper to the individual electronic device 103 through the auto tuning function.

For example, after receiving the condition for entering or releasing the emergency power mode from the server 300, the controller 120 may adjust a time or a battery capacity ratio to enter the emergency power mode according to entire available capacity of the battery 140 of the electronic device 103 and then set the adjusted condition in the electronic device 103.

According to a signal received by the input voltage detecting unit 170, the controller 120 may perform a control to turn off the switch 110 when power supplied from the power adaptor 200 is not available.

The controller 120 may adjust the condition received from the server 300 by using a lookup table storing a setting condition corresponding to the entire available capacity or a specific algorithm in which a setting condition corresponding to the entire available capacity is obtained.

The controller 120 may check whether the battery 140 is abnormal and when the battery 140 is abnormal according to the checked result, maintain the switch 110 on. When the battery 140 is abnormal and cannot supply power necessary for the system load 130, the electronic device 103 may not be allowed to enter the emergency power mode in order to prevent the electronic device 103 from operating.

The system load 130 receives power from the power adaptor 200 or the battery 140 according to on/off of the switch 110.

When the electronic device 103 enters the emergency power mode in a state of being connected to the power adaptor 200, the battery 140 may supply power to the system load 130.

The charging module 150 may receive power supplied from the power adaptor 200 when the switch 110 is on. When the switch 110 is off, the power is not supplied to the charging module 150.

The communication interface unit 180 may receive a signal from the server 300.

According to an embodiment of the present disclosure, the communication interface unit 180 may receive a command for allowing the electronic device 103 to enter the emergency power mode from the server 300.

According to an embodiment of the present disclosure, the communication interface unit 120 may receive a setting condition for allowing the electronic device 103 to enter the emergency power mode from the server 300. The condition for entering the emergency power mode may be a time to enter the emergency power mode, remaining capacity of the battery 140 for entering the emergency power mode, or a ratio of remaining capacity to the entire available capacity of the battery 140.

For example, the communication interface unit 180 may receive, from the server 300, a first time to enter the emergency power mode and a setting condition in which a battery capacity ratio is a first setting value or greater. Accordingly, when the time is the first time and the battery capacity ratio is the first setting value or greater, the controller 120 may set a condition for allowing the electronic device 103 to enter the emergency power mode.

For another example, the communication interface unit 180 may receive, from the server 300, a second time to exit the emergency power mode or a setting condition in which the battery capacity ratio is smaller than a second setting value. Accordingly, when the time becomes the second time or the battery capacity ratio is smaller than the second setting value, the controller 120 may set a condition for releasing the emergency power mode of the electronic device 103.

The communication interface unit 180 may transmit and receive data through a wired or wireless network or wired serial communication. At this point, the network may include the internet, a local area network (LAN), a wireless LAN, a wide area network (WAN), or a personal area network (PAN). In addition, the network may include short range communication technology including Bluetooth (BT), radio frequency identification (RFID), infrared data association (IrDA), ultra wideband (UWB), ZigBee, Wi-Fi Direct (WFD), or near field communication (NFC). However, the present disclosure is not limited hereto, and a person skilled in the art may appreciate that the network may be another kind of network capable of transmitting and receiving information.

According to various embodiments of the present disclosure, the electronic device 103 may further include an input voltage detecting unit 170. When the power adaptor 200 is connected to the electronic device 103, the input voltage detecting unit 170 may determine whether the power adaptor 200 is connected. In addition, the input voltage detecting unit 170 may determine whether power supplied from the power adaptor 200 connected to the electronic device 103 is available in the electronic device 103. The controller 120 may receive a determination result of the input voltage detecting unit 170 and control switching (i.e., on/off) of the switch 110 according to the determination result. For example, when the input voltage detecting unit 170 determines that the power supplied from the power adaptor 200 is not available in the electronic device 103, the controller 120 may turn off the switch 110. The power adaptor 200 may convert commercial AC power into a DC voltage used in the electronic device 103 and supply the DC voltage to the electronic device 103. According to an embodiment of the present disclosure, the input voltage detecting unit 170 may be included in the controller 120.

The server 300 may transmit a command for allowing the electronic device 103 to enter or release the emergency power mode or a setting condition for entering or releasing the emergency power mode, to an individual electronic device 103 connected to a network through the network.

According to an embodiment of the present disclosure, when a predetermined time arrives or a predetermined event occurs in the individual electronic device 103, the server 300 may transmit a command for entry to the emergency power mode to the individual electronic devices 103 connected to the network located inside a single building. For example, the predetermined event may be a nationwide shortage of power supply or a shortage of power supply in a corresponding building.

According to an embodiment of the present disclosure, the server 300 may transmit a setting condition for entering the emergency power mode to individual electronic devices 103 connected to a network in order that the individual electronic devices 103 use the emergency power mode at a predetermined time. The server 300 may adjust and then transmit the setting condition over time. For example, as a time period in which power supply becomes large approaches, the server 300 may put forward a time condition for entering the emergency power mode or put off a time condition for releasing the emergency power mode.

As described above, according to a signal received from the server 300, the electronic device 103 may save a large amount of power as a whole by allowing a plurality of electronic devices 103 to enter the emergency power mode to cut off use of AC power in the plurality of electronic devices 103.

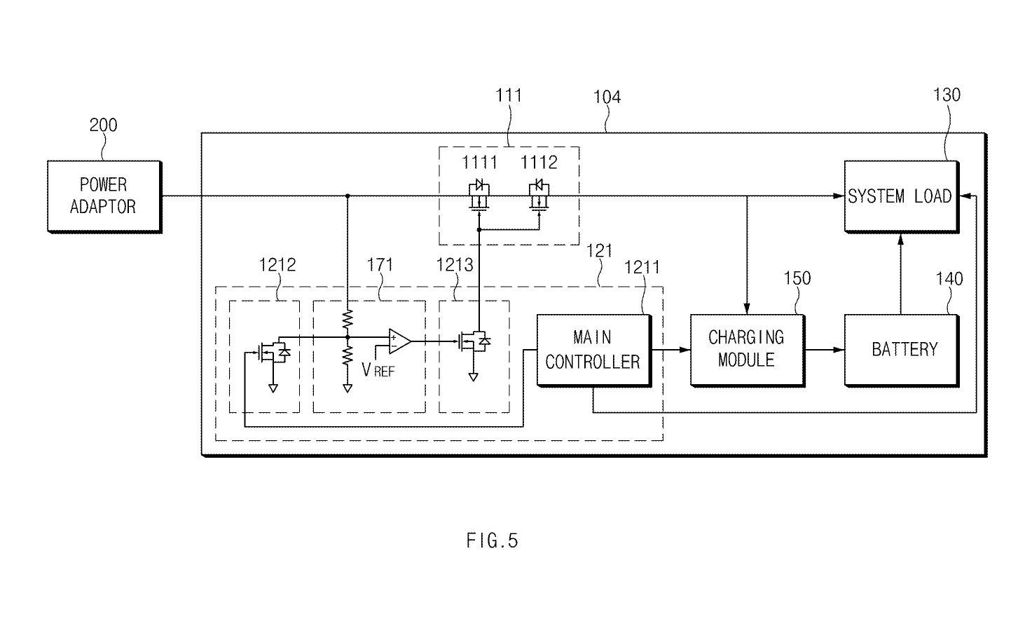

FIG. 5 is a block diagram of an electronic device according to various embodiments of the present disclosure.

Referring to FIG. 5, the electronic device 104 may be configured with a switch 111, a controller 121, a system load 130, a battery 140, a charging module 150, and an input voltage detecting unit 171. The system load 130, battery 140, charging module 150, and power adaptor 200 illustrated in FIG. 5 respectively correspond to the system load 130, battery 140, charging module 150, and power adaptor 200 illustrated in FIG. 1. In relation hereto, repeated descriptions are omitted.

The switch 111 switches (i.e., opens or closes) to selectively supply power from a power adaptor 200 connected to the electronic device 104 according to a signal received from the controller 121. According to various embodiments of the present disclosure, the switch 111 may include a first FET 1111 and a second FET 1112. However, the switch 111 is not limited hereto and may be configured with various types capable of supplying power from the power adaptor 200. The switch 110 may pass/cut off power supplied from the power adaptor 200 according to operations of the first and second FETs 1111 and 1112.

In a state where the power adaptor 200 is connected to the electronic device 104, when the electronic device 104 enters the emergency power mode, the switch 111 is turned off to cut off power supplied from the power adaptor 200.

The controller 121 may be configured with an input voltage detecting unit 171, a main controller 1211, a first control switch 1212, and a second control switch 1213. The controller 121 may control switching (i.e., on/off) of the switch 111 according to a signal received from the input voltage detecting unit 171 or the main controller 1211. When the power adaptor 200 is connected to the electronic device 104, the input voltage detecting unit 171 may determine whether the power adaptor 200 is connected, through detection of an input voltage. In addition, the input voltage detecting unit 171 may determine whether the connected power adaptor 200 is available to the electronic device 104. The input voltage detecting unit 171 according to the present embodiment may include a comparator and two or more resistors. The input voltage detecting unit 171 may compare voltages divided by the resistors with a reference voltage V_{REF} and, according to the compared result, determine whether a voltage supplied from the power adaptor 200 is available in the electronic device 104.

For example, when the electronic device 104 uses a DC voltage of 19 V and the power adaptor 200 supplying the DC voltage of 19 V is connected to the electronic device 104, the input voltage detecting unit 171 may compare voltages divided by the resistors thereof with the reference voltage V_{REF} and output a high signal to the second control switch 1213. The second control switch 1213 may turn on the switch 111 according to a signal received from the input voltage detecting unit 171. On the contrary, when the power adapter 200 supplies a voltage that is incompatible with the electronic device 104, the input voltage detecting unit 171 may compare voltages divided by the resistors with the reference voltage V_{REF} and output a low signal to the second control switch 1213. The second control switch 1213 may turn off the switch 111 according to a signal received from the input voltage detecting unit 171.

The main controller 1211 may output a signal for turning on/off the first control switch 1212 according to whether the electronic device 104 enters an emergency power mode. When the electronic device 104 enters the emergency power mode, the main controller 1211 transmits a signal to the first control switch 1212 to allow a low signal to be output from the first control switch 1212. Accordingly, the input voltage detecting unit 171 outputs a low signal to the second control switch 1213, the second control switch 1213 turns off the switch 111 according to a signal received from the input voltage detecting unit 171. In addition, the main controller 1211 receives an indication from the battery 140 whether the battery 140 is abnormal and controls switching (i.e., on/off) of the switch 111. When the battery 140 is abnormal, the main controller 1211 transmits a signal to the first control switch 1212 to allow a high signal to be output from the first control switch 1212. Accordingly, the input voltage detecting unit 171 outputs a high signal to the second control switch 1213, and the second control switch 1213 turns on the switch 111 according to a signal received from the input voltage detecting unit 171. When the battery 140 is abnormal and not able to supply power necessary for the system load 130, the main controller 1211 prevents the electronic device 104 from entering the emergency power mode in order to prevent the electronic device 104 from operating.

In addition, the main controller 1211 may perform a control so that the electronic device 104 enters the emergency power mode on the basis of a user setting or a signal received from a server (not shown). Alternatively, the main controller 1211 may perform a control so that the electronic device 104 exits the emergency power mode according to a user setting or a signal received from a server (not shown).

According to reduction of the entire available capacity by battery charging and discharging, the main controller 1211 may adjust the setting condition for entering and releasing the emergency power mode, which is set in the main controller 1211.

The main controller 1211 according to the present embodiment may correspond to a CPU or microcomputer of the electronic device 104.

The first control switch 1212 may be turned on/off according to a signal received from the main controller 1211. According to switching (i.e., on/off) of the first control switch 1212, a signal output from the input voltage detecting unit 171 may vary and switching (i.e., on/off) of the second control switch 1213 may be determined.

The second control switch 1213 may control switching (i.e., on/off) of the switch 111 according to a signal received from the input voltage detecting unit 171.

The controller 121 illustrated in the present embodiment corresponds to an embodiment of a configuration in which switching (i.e., on/off) of the switch 111 may be controlled according to a voltage detected in the input voltage detecting unit 171 and a signal from the main controller 1211, but is not limited to the configuration illustrated in FIG. 5. According to various embodiments of the present disclosure, the controller 121 may be implemented with various circuits capable of controlling switching (i.e., on/off) of the switch 111 according to a voltage detected by the input voltage detecting unit 171 and a signal from the main controller 1211.

The system load 130 receives power from the power adaptor 200 or the battery 140 according to switching (i.e., on/off) of the switch 111.

When the electronic device 103 enters the emergency power mode in a state of being connected to the power adaptor 200, the battery 140 may supply power to the system load 130.

The charging module 150 may receive power from the power adaptor 200 when the switch 111 is on. When the switch 110 is off, the power is not supplied to the charging module 150.

The power adaptor 200 may convert commercial AC power into a DC voltage used in the electronic device 104 and supply the DC voltage to the electronic device 104.

According to various embodiments of the present disclosure, the electronic device may include a switch for opening/closing power supplied from the power adaptor connected to the electronic device, a system load of the electronic device, which receives power from the power adaptor or the battery connected to the electronic device according to a position (i.e., on/off) of the switch, and a controller turning off the switch when the electronic device enters the emergency power mode in a state where the power adaptor is connected to the electronic device.

According to various embodiments of the present disclosure, when the electronic device enters the emergency power mode, the switch may cut off power supplied from the power adaptor and the system load receives power from the battery.

According to various embodiments of the present disclosure, the controller may enter the emergency power mode according to a user setting or a signal from the server. Alternatively, the controller may enter the emergency power mode or set a condition for entering the emergency power mode on the basis of a signal received from the server.

According to various embodiments of the present disclosure, the controller may enter the emergency mode when a capacity of the battery is a first setting value or greater at a first time. Alternatively, the controller may perform a control to exit the emergency power mode when a second time arrives or the capacity of the battery falls to a value smaller than a second setting value.

According to various embodiments of the present disclosure, the electronic device may further include a user interface unit receiving a user input for setting at least one of the first time, first setting value, second time, and second setting value. For example, at least one of the first and second setting values may represent a ratio of remaining capacity to the entire available capacity of the battery.

According to various embodiments of the present disclosure, the controller may adjust at least one of the first time, first setting value, second time, and second setting value according to a reduction of the entire available capacity of the battery due to battery charging and discharging.

According to various embodiments of the present disclosure, the controller may adjust at least one of the first time, first setting value, second time, and second setting value on the basis of a lookup table storing at least one of the first time, first setting value, second time, and second setting value corresponding to the entire available capacity.

According to various embodiments of the present disclosure, the controller may obtain at least one of the first time, first setting value, second time, and second setting value according to reduced entire available capacity by using a specific algorithm.

According to various embodiments of the present disclosure, the controller may check whether the battery is abnormal and cannot enter the emergency power mode according to the result.

According to various embodiments of the present disclosure, the controller may perform a control to exit the emergency power mode when the power adaptor is disconnected from the electronic device in the emergency power mode.

According to various embodiments of the present disclosure, the controller may perform a control to enter the emergency power mode on the basis of a signal from the server and exit the emergency power mode when disconnected from a network in the emergency power mode.

According to various embodiments of the present disclosure, when the electronic device enters the emergency power mode, the controller allows the electronic device to enter a low power mode.

According to various embodiments of the present disclosure, when the electronic device enters the emergency power mode, the controller may temporally hold at least one job and perform the held job after releasing the emergency power mode.

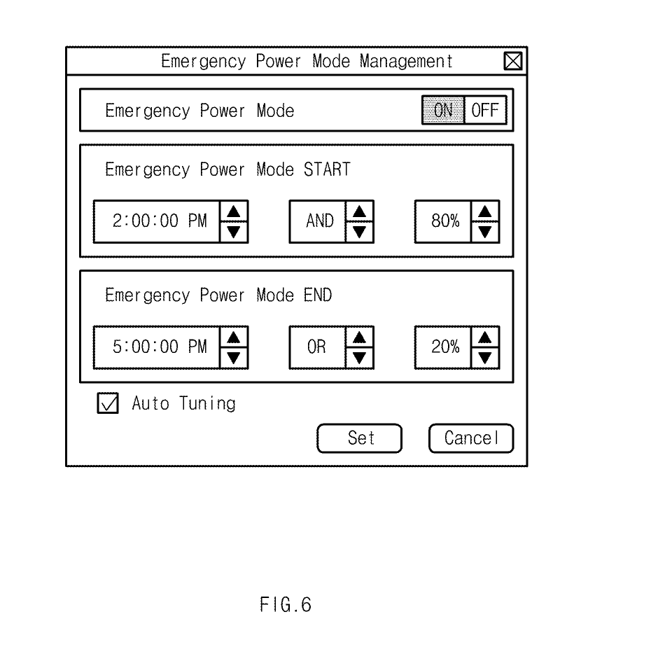

FIG. 6 is a user interface screen on which an emergency power mode is set according to various embodiments of the present disclosure.

Referring to FIG. 6, an electronic device 100 may display a user interface screen for entering or releasing an emergency power mode. A user may check an on/off state of the emergency power mode on the user interface screen and set on/off of the emergency power mode. The user may set any one of a start condition of the emergency power mode and an end condition of the emergency power mode displayed on the user interface screen. After selecting a desired start condition and end condition, the user may press a ‘Set’ button for setting to set a desired condition for entering or releasing the emergency power mode.

FIG. 6 illustrates, as the start and end conditions of the emergency power mode, a time to enter the emergency power mode, a battery capacity ratio for entering the emergency power mode, a time to end the emergency power mode, and a battery capacity ratio for releasing the emergency power mode. However, the present embodiment is not limited hereto, and the electronic device 100 may additionally set various conditions for starting and ending the emergency power mode.

According to various embodiments of the present disclosure, when the user sets a condition for entering or releasing the emergency power mode as illustrated in FIG. 6, and when it is 2 PM and a battery capacity ratio of the electronic device 100 is 80% or greater, the controller 120 may allow the electronic device 100 to enter the emergency power mode. Accordingly, a switch for controlling power supplied from the power adaptor 200 is turned off and the system load 130 of the electronic device 100 receives power from the battery 140. In addition, when it is 5 PM or a battery capacity ratio of the electronic device 100 is smaller than 20%, the controller 120 may end the emergency power mode of the electronic device 100. Accordingly, a switch for controlling power supplied from the power adaptor 200 is turned on and the system load 130 of the electronic device 100 receives power from the power adaptor 200.

In such a way, the controller 120 may set a condition for starting the emergency power mode or ending the emergency power mode in the electronic device 100 on the basis of a user input received through the user interface unit 160.

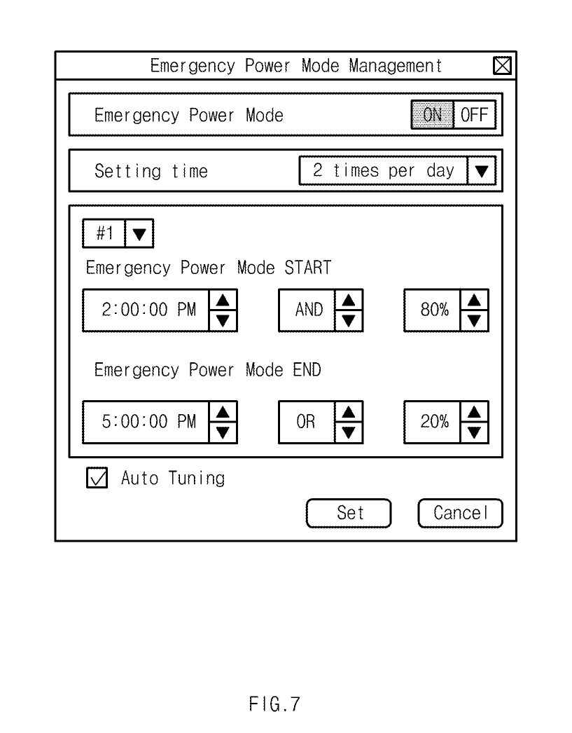

FIG. 7 is a user interface screen on which an emergency power mode is set according to various embodiments of the present disclosure.

Referring to FIG. 7, a user interface screen for setting the number of times that the electronic device 100 enters an emergency power mode may is illustrated. For example, the user may set “2 times per day” on the user interface screen. According to the number of times selected by the user, the user may repeatedly set a start condition or end condition of an emergency power mode. After selecting #1, the user selects a desired start condition and end condition and after selecting #2, the user selects a desired start condition and end condition and then presses a ‘Set’ button for entering the selected settings. Then the user may set the electronic device to enter the emergency power mode 2 times per day.

Besides the time to enter the emergency power mode, the battery capacity ratio for entering the emergency power mode, the time to end the emergency power mode, and the battery capacity ratio for releasing the emergency power mode shown in FIG. 7, various conditions for starting and ending the emergency power mode may be set.

In various embodiments of the present disclosure, on the basis of a user input, a condition for starting the emergency power mode or ending the emergency power mode is set in the electronic device 100. Besides, the electronic device 100 may set therein a condition for starting the emergency power mode or ending the emergency power mode on the basis of a signal received from the server.

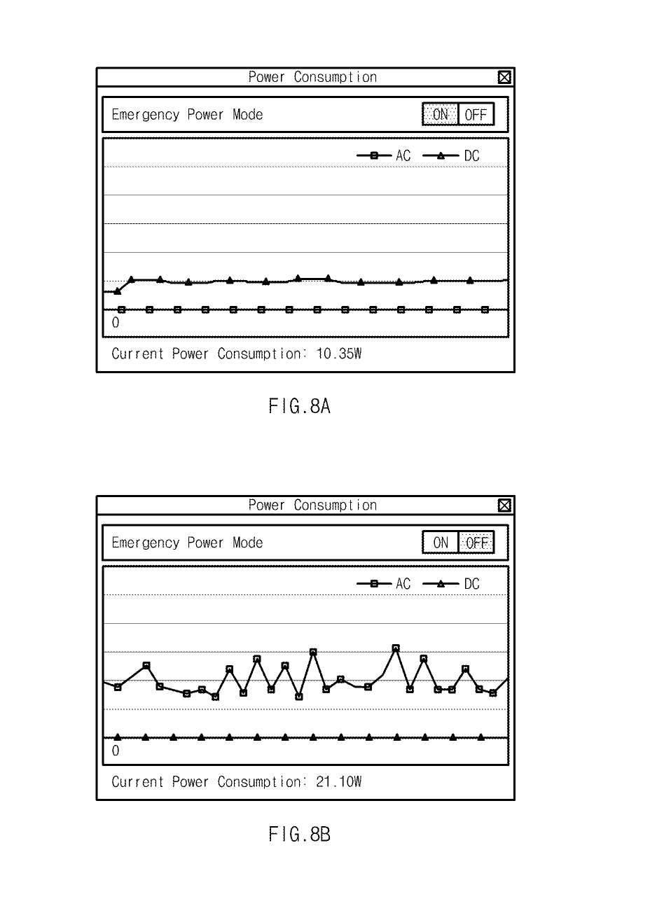

FIG. 8A is an emergency power mode screen for power consumption consumed by the electronic device.

Referring to FIG. 8A, when the electronic device 100 enters the emergency power mode, the controller 120 turns off the switch 110 to cut off power supplied from the power adaptor 200. According to a graph of FIG. 8A, it may be confirmed that AC power supplied through the power adaptor 200 is 0 W, and a DC power is supplied from the battery 140. The system load 130 may receive power from the battery 140 and be driven.

FIG. 8B is a normal mode screen for power consumption consumed by the electronic device.

Referring to FIG. 8B, when the power adaptor 200 is connected to the electronic device 100 and the electronic device 100 is in a normal mode, the controller 120 may turn on the switch 110 to receive power from the power adaptor 200.

According to a graph of FIG. 8B, it may be confirmed that DC power supplied through the battery 140 is 0 W, and an AC power is supplied through the power adaptor 200. Accordingly, the system load 130 may receive power from the power adaptor 200 and be driven.

Referring to FIGS. 8A and 8B, when the system load 130 receives power from the battery 140, the power consumption is 10.35 W, and when the system load 130 receives power from the power adaptor 200, the power consumption is 21.10 W. In this way, the electronic device 100 may effectively reduce power consumption by using the emergency power mode. When at least one electronic device 100 is allowed to enter the emergency power mode, an effect of saving power consumption may become larger.

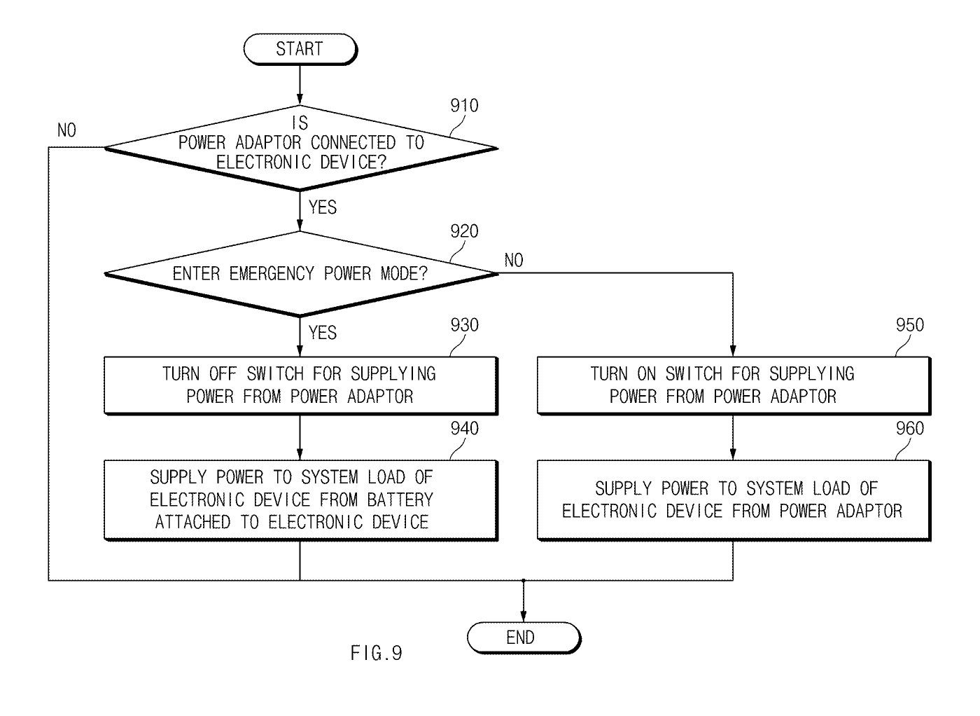

FIG. 9 illustrates a flowchart of a method for controlling power supply in an electronic device according to various embodiments.

Referring to FIG. 9, the method is configured with operations processed by the electronic device 100 illustrated in FIGS. 1, 2, 3, 4, and 5. Accordingly, although omitted hereinafter, it may be seen that contents described in the above in relation to the electronic device 100 illustrated in FIGS. 1 to 5 may be applied to the flowchart illustrated in FIG. 9.

In operation 910, the controller 120 may determine whether the power adaptor 200 is connected to the electronic device 100. When the power adaptor 200 is connected to the electronic device 100, the controller performs operation 920, and when the power adaptor 200 is not connected to the electronic device 100, the controller 120 ends a process for entering the emergency power mode.

In operation 920, the controller 120 may determine whether the electronic device 100 enters the emergency power mode. When the electronic device 100 enters the emergency power mode, the controller 120 performs operation 930 and when the electronic device 100 does not enter the emergency power mode, the controller 120 may perform operation 950.

In operation 930, the controller 120 may turn off the switch 110 for supplying power from the power adaptor 200. Accordingly, power supplied from the power adaptor 200 may be cut off.

In operation 940, the controller 120 performs a control so that power is supplied to the system load 130 of the electronic device 100 from the battery 140 attached to the electronic device 100.

In operation 950, the controller 120 may turn on the switch 110 for supplying power from the power adaptor 200.

In operation 960, the controller 120 may perform a control so that power is supplied from the power adaptor 200 to the system load 130 of the electronic device 100.

According to various embodiments of the present disclosure, a method for controlling power supply in an electronic device may include an operation for determining whether a power adaptor is connected to the electronic device, an operation for determining whether the electronic device enters the emergency power mode when connected to the power adaptor, an operation for turning off the switch for supplying power from the power adaptor when the electronic device enters the emergency power mode, an operation for cutting off the power supplied from the power adaptor in response to switch off, and an operation for supplying power from the battery attached to the electronic device to the system load of the electronic device.

According to various embodiments of the present disclosure, the electronic device may enter the emergency power mode according to a user setting or reception of a signal from the server.

According to various embodiments of the present disclosure, when a capacity of the battery is a first setting value or greater at a first time, the electronic device enters the emergency power mode, and when a second time arrives or a capacity of the battery falls to a value smaller than a second setting value, the electronic device exits the emergency power mode. For example, at least one of the first and second setting values may represent a ratio of remaining capacity to the entire available capacity of the battery.

According to various embodiments of the present disclosure, a method for controlling power supply in the electronic device may further include an operation for adjusting at least one of the first time, first setting value, second time, and second setting value according to reduction of the entire available capacity of the battery due to battery charging and discharging.

According to various embodiments of the present disclosure, in the operation for adjusting, at least one of the first time, first setting value, second time, and second setting value is adjusted on the basis of a lookup table storing at least one of the first time, first setting value, second time, and second setting value corresponding to the entire available capacity.

According to various embodiments of the present disclosure, power consumption can be effectively reduced without the burden of additional costs by allowing an electronic device to enter an emergency power mode at peak times of power consumption to cut off the electronic device from using AC power. Since the electronic device enters the emergency power mode according to an individual state thereof, the shortage of power supply can be effectively addressed without an inconvenience caused by power saving by a user.

Each of the above-described elements of the electronic device according to various embodiments of the present disclosure may include one or more components and the name of a corresponding element may be differed according to a kind of the electronic device. The electronic device according to various embodiments of the present disclosure may include at least one of the above-described elements, may not include some of the elements, or may further include another element. Additionally, some of elements in an electronic device according to various embodiments of the present disclosure are combined to be configured as one entity, so that functions of corresponding elements before combination are performed identically.

The term “module” used in various embodiments of the present disclosure may mean a unit including a combination of at least one of hardware, software, and firmware. The term “module” may be interchangeably used with the term “unit”, “logic”, “logical block”, “component”, or “circuit.” A “module” may be a minimum unit or part of an integrally configured component. A “module” may be a minimum unit performing at least one function or part thereof. A “module” may be implemented mechanically or electronically. For example, “module” according to various embodiments of the present disclosure may include at least one of an application-specific integrated circuit (ASIC) chip performing certain operations, field-programmable gate arrays (FPGAs), or a programmable-logic device, all of which are known or to be developed in the future.

According to various embodiments of the present disclosure, at least part of a device (for example, modules or functions thereof) or a method (for example, operations) according to this disclosure may be implemented using an instruction stored in computer-readable storage media, for example, in the form of a programming module. When at least one processor executes the instruction, it may perform a function corresponding to the instruction. The non-transitory computer-readable storage media may include the memory, for example. At least part of the programming module may be implemented (for example, executed) by the processor, for example. At least part of the programming module may include a module, a program, a routine, sets of instructions, or a process to perform at least one function, for example.

The computer-readable storage media may include Magnetic Media such as a hard disk, a floppy disk, and a magnetic tape, Optical Media such as Compact Disc Read Only Memory (CD-ROM) and DVD, Magneto-Optical Media such as Floptical Disk, and a hardware device especially configured to store and perform a program instruction (for example, a programming module) such as ROM, Random Access Memory (RAM), and flash memory. Additionally, a program instruction may include high-level language code executable by a computer using an interpreter in addition to machine code created by a complier. The hardware device may be configured to operate as at least one software module to perform an operation of various embodiments and vice versa.

A module or a programming module according to various embodiments of the present disclosure may include at least one of the above-mentioned elements, may not include some of the above-mentioned elements, or may further include another element. Operations performed by a module, a programming module, or other components according to various embodiments of the present disclosure may be executed through a sequential, parallel, repetitive or heuristic method. Additionally, some operations may be executed in a different order or may be omitted. Or, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a switch configured to selectively adjust power supplied from a power adaptor connected to the electronic device;
a system load configured to receive power from at least one of the power adaptor or a battery connected to the electronic device; and
a controller configured to turn off the switch when entering an emergency power mode in a state where the power adaptor is connected to the electronic device.

2. The electronic device of claim 1, wherein the controller is further configured to control the switch to cut off power supplied from the power adaptor and supply power from the battery to the system load when entering the emergency power mode.

3. The electronic device of claim 1, wherein the controller is further configured to activate the emergency power mode according to a user setting or a signal from a server.

4. The electronic device of claim 3, wherein the controller is further configured to activate the emergency power mode or set a condition for entering the emergency power mode in response to a signal received from the server.

5. The electronic device of claim 1, wherein the controller is further configured to activate the emergency power mode when a capacity of the battery is a first setting value or greater at a first time.

6. The electronic device of claim 5, wherein the controller is further configured to control to deactivate the emergency power mode when a second time different from the first time arrives or the capacity of the battery falls to a value smaller than a second setting value different from the first setting value.

7. The electronic device of claim 6, further comprising a user interface unit configured to receive a user input for setting at least one of the first time, the first setting value, the second time and the second setting value.

8. The electronic device of claim 6, wherein at least one of the first and second setting values represents a ratio of remaining battery capacity to entire available capacity of the battery.

9. The electronic device of claim 6, wherein the controller is further configured to adjust at least one of the first time, the first setting value, the second time and the second setting value according to a reduction of entire available capacity of the battery due to battery charging and discharging.

10. The electronic device of claim 9, wherein the controller is further configured to adjust at least one of the first time, the first setting value, the second time and the second setting value on a basis of a lookup table storing at least one of the first time, the first setting value, the second time and the second setting value corresponding to the entire available capacity.

11. The electronic device of claim 9, wherein the controller is further configured to obtain at least one of the first time, the first setting value, the second time and the second setting value according to reduced entire available capacity by using a specific algorithm.

12. The electronic device of claim 1, wherein the controller is further configured to:
check whether the battery is abnormal and enter the emergency power mode when the battery is abnormal;
control to deactivate the emergency power mode when the power adaptor is disconnected from the electronic device in the emergency power mode; or
control to activate the emergency power mode according to a signal from a server, and deactivate the emergency power mode when disconnected from a network in the emergency power mode.

13. The electronic device of claim 1, wherein the controller is further configured to:
allow the electronic device to activate a low power mode when entering the emergency power mode; or
temporally hold at least one job and perform the held job after release from the emergency power mode when entering the emergency power mode.

14. An electronic device comprising:
a system load configured to receive power from a power adaptor or a battery connected to the electronic device; and
a controller configured to perform a control to transmit, to the power adaptor, a signal for turning off a switch comprised in the power adaptor when entering the emergency power mode in a state where the power adaptor is connected to the electronic device.

15. A method for controlling power supply, the method comprising:
determining whether a power adaptor is connected to an electronic device;
turning off a switch for supplying power from the power adaptor when the electronic device is connected to the power adaptor to activate an emergency power mode;
cutting off power supplied from the power adaptor in response to the turning off of the switch; and
supplying power from a battery attached to the electronic device to a system load of the electronic device.

16. The method of claim 15, wherein the electronic device activates the emergency power mode according to a user setting or reception of a signal from the server.

17. The method of claim 15, wherein the electronic device activates the emergency power mode when a capacity of the battery is a first setting value or greater at a first time, and deactivates the emergency power mode when a second time arrives or the capacity of the battery falls to a value smaller than a second setting value.

18. The method of claim 17, wherein at least one of the first and second setting values represents a ratio of remaining capacity to entire available capacity of the battery.

19. The method of claim 17, further comprising adjusting at least one of the first time, the first setting value, the second time, and the second setting value according to a reduction of entire available capacity of the battery due to battery charging and discharging.

20. The method of claim 19, wherein the adjusting of the at least one of the first time, the first setting value, the second time, and the second setting value comprises adjusting at least one of the first time, the first setting value, the second time and the second setting value on a basis of a lookup table storing at least one of the first time, the first setting value, the second time and the second setting value corresponding to the entire available capacity.
